(19) United States
(12) Patent Application Publication
(10) Pub. No.: US 2016/0088135 A1
(43) Pub. Date: Mar. 24, 2016

(54) Smart Wireless Watchbands and Lanyards

(71) Applicant: Plantronics, Inc., Santa Cruz, CA (US)

(72) Inventors: Benjamin Alfred Gesing, Santa Cruz, CA (US); Barry C Ferris, Santa Cruz, CA (US); Erik Perotti, Santa Cruz, CA (US); Ken Comstock, Scotts Valley, CA (US); Scott Walsh, Foxham (GB)

(73) Assignee: Plantronics, Inc., Santa Cruz, CA (US)

(21) Appl. No.: 14/493,690

(22) Filed: Sep. 23, 2014

(51) Int. Cl. H04M 1/21

(52) U.S. Cl. CPC H04M 1/21

(57) ABSTRACT

Disclosed are watchbands, watchband links, and lanyards, where the watchbands comprise a band, wherein the band comprises (i) a sensor configured to generate a sensor signal representing a physical quantity, and (ii) a wireless transmitter configured to transmit a wireless signal representing the sensor signal; and a closure structure operable to close the watchband.

### FIELD

The present disclosure relates generally to the field of wireless communications. More particularly, the present disclosure relates to wearable wireless devices.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Each of us has a certain style, expressed through our clothing, jewelry, glasses, and the like. Many of us find great joy in a favorite accessory, an emotional bond. Perhaps the article says something about who we are. But, as time marches on, new technologies are introduced that improve our fitness, wellness, and increase our knowledge and understanding of ourselves and our environments. At best, these activity trackers are cold and functional, but very few people would, if pushed, choose an activity tracker over a watch from a grandparent.

Watch owners have a high sense of emotional attachment to their time pieces as they are expensive status symbols, gifts from close friends, or family heirlooms. Self-winding watches need to be worn or turned frequently, as the watch winds itself with the natural gesture movement of the wearer. Some high-end watches are valuable enough to the owner that they store self-winding watches in electronic cases that routinely turn them to ensure they are constantly wound and therefore accurate.

Over the past decade the growth of sensor technologies alongside rising health awareness have created a multi-million dollar market of sensor-enabled wearable devices that track personal biometric and activity data. Many luxury watch owners are interested in monitoring their health and activity with the aforementioned digital wearable tracking devices. This typically requires the user to wear multiple devices on one wrist, one device on each wrist, or give up wearing their luxury watch altogether.

But wearing an analog luxury watch and digital activity tracker on the same wrist adds uncomfortable bulk to the wrist and lower arm, restricts natural movement of the wrist as the area around the protruding wrist bone becomes crowded, and may create an awkward social perception. And using both wrists adds uncomfortable bulk to whichever hand (dominant or non-dominant) previously was unoccupied. That wrist may be unconditioned to wearing physical device. The thickness of the band on the wrist underside may hinder the ability to perform certain activities such as typing on a computer keyboard.

Similarly, millions of working professionals in developed countries are required to swipe a badge or key card worn on a belt loop at the waist or around the neck to identify themselves and gain access to the facilities in which they work. This is particularly prevalent in Europe and North America. These devices are easy to lose, and to forget to put on. They use antiquated technology, with no ability to “leash” to a smartphone or otherwise remind the user to wear them. They are easily transferable with no user authentication required.

### SUMMARY

In general, in one aspect, an embodiment features a watchband comprising: a band, wherein the band comprises (i) a sensor configured to generate a sensor signal representing a physical quantity, and (ii) a wireless transmitter configured to transmit a wireless signal representing the sensor signal; and a closure structure operable to close the watchband.

Embodiments of the watchband may include one or more of the following features. In some embodiments, the wireless signal is a first wireless signal, and the band further comprises: a memory configured to store an identification code; wherein the wireless transmitter is further configured to transmit a second wireless signal representing the identification code. In some embodiments, the wireless signal is a first wireless signal, and the band further comprises: a wireless receiver configured to receive a second wireless signal representing a message; and a notifier configured to produce a user-perceivable notification based on the message. Some embodiments comprise a power supply.

In general, in one aspect, an embodiment features a first watchband link comprising: an attachment structure configured to receive a second watchband link; a sensor configured to generate a sensor signal representing a physical quantity; and a wireless transmitter configured to transmit a wireless signal representing the sensor signal.

Embodiments of the first watchband link may include one or more of the following features. In some embodiments, the wireless signal is a first wireless signal, and the first watchband link further comprises: a memory configured to store an identification code; wherein the wireless transmitter is further configured to transmit a second wireless signal representing the identification code. In some embodiments, the wireless signal is a first wireless signal, and the first watchband link further comprises: a wireless receiver configured to receive a second wireless signal representing a message; and a notifier configured to produce a user-perceivable notification based on the message. Some embodiments comprise a power supply.

In general, in one aspect, an embodiment features a lanyard comprising: a sensor configured to generate a sensor signal representing a physical quantity; and a wireless transmitter configured to transmit a wireless signal representing the sensor signal.

Embodiments of the lanyard may include one or more of the following features. Some embodiments comprise an attachment structure configured to attach to an object, wherein the attachment structure comprises the sensor and the wireless transmitter. Some embodiments comprise a closure structure configured to close the lanyard, wherein the closure structure comprises the sensor and the wireless transmitter. In some embodiments, the wireless signal is a first wireless signal, and the lanyard further comprises: a memory configured to store an identification code; wherein the wireless transmitter is further configured to transmit a second wireless signal representing the identification code. In some embodiments, the wireless signal is a first wireless signal, and the lanyard further comprises: a wireless receiver configured to receive a second wireless signal representing a message; and a notifier configured to produce a user-perceivable notification based on the message. Some embodiments comprise a power supply.

The details of one or more implementations are set forth in the accompanying drawings and the description below. Other features will be apparent from the description and drawings, and from the claims.

### DESCRIPTION OF DRAWINGS

FIGS. 1a and 1b show elements of a replaceable watchband according to one embodiment.

FIG. 2 shows a process for the replaceable watchband of FIG. 1 according to one embodiment.

FIGS. 3a and 3b show elements of a watchband having a replaceable link implemented according to one embodiment.

FIGS. 4a and 4b show elements of a lanyard according to one embodiment.

The leading digit(s) of each reference numeral used in this specification indicates the number of the drawing in which the reference numeral first appears.

### DETAILED DESCRIPTION

Embodiments of the present disclosure provide smart wireless devices that may be incorporated in wearable devices. In some embodiments, the smart wireless device may be a watchband, or a link in a watchband. In some embodiments, the smart wireless device may be a lanyard, part of a lanyard, or attachable to a lanyard. In some embodiments, the smart wireless devices may be implemented as other devices, as a part of such devices, or as attachable to such devices.

The smart wireless devices may include one or more sensors to collect sensor data, one or more notifiers to generate user-perceivable notifications, or both. The smart wireless devices may also include a wireless transmitter, a wireless receiver, or both, as well as a power supply.

Other features are contemplated as well.

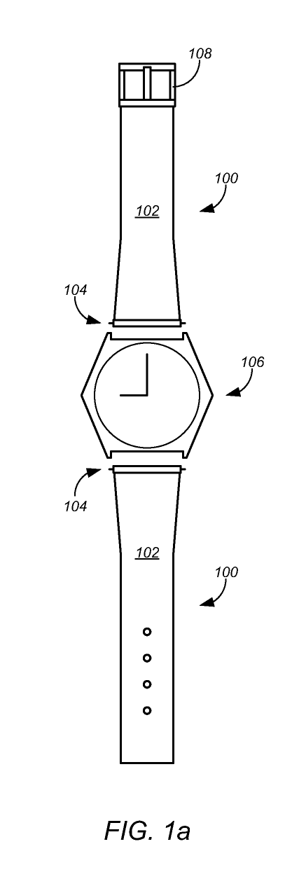

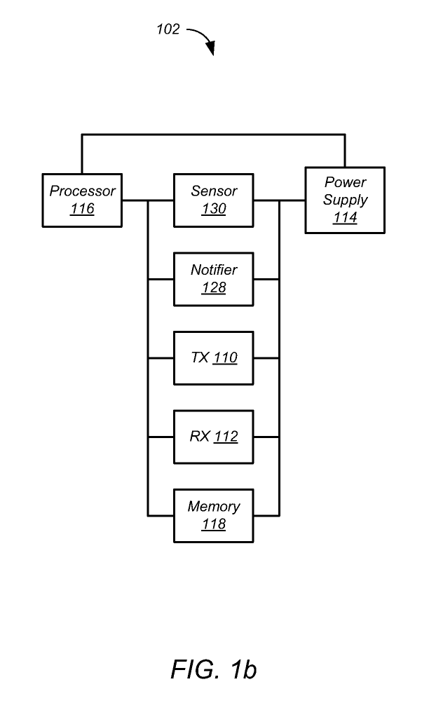

Most wristwatches feature replaceable watchbands. FIGS. 1a and 1b show elements of such a watchband 100 according to one embodiment. Although in the described embodiment elements of the watchband 100 are presented in one arrangement, other embodiments may feature other arrangements. For example, elements of the watchband 100 may be implemented in hardware, software, or combinations thereof.

Referring to FIG. 1a, the watchband 100 may include a band 102 and a closure structure 108 operable to open and close the watchband 100. The band 102 may be one or more straps, a bracelet comprising a plurality of links, or the like. The watchband 100 may include an attachment structure 104 configured to receive a wristwatch 106. For example, the attachment structure 104 may be a sleeve configured to receive a spring-loaded pin that fits into a pair of lugs on the wristwatch 106. However, the attachment structure 104 may take other forms. The closure structure 108 may include a clasp, buckle, or the like.

Referring to FIG. 1b, The watchband 100 may include a sensor 130, a notifier 128, a wireless transmitter (TX) 110, a wireless receiver (RX) 112, a power supply 114, a processor 116, and a memory 118. The sensor 130 may be any sort of sensor. For example, the sensor 130 may be an accelerometer, a gyroscope, a heart rate monitor, a blood pressure monitor, a skin temperature monitor, a fingerprint reader, a muscle tension sensor, a skin conductivity sensor, a geolocation sensor such as a GPS receiver, a compass, a capacitive don/doff sensor, an altimeter, an optical sensor such as a camera, a gas detector, a radiation sensor, and the like. The notifier 128 may provide optical notifications, audible notifications, haptic notifications, and the like.

The wireless transmitter 110 and the wireless receiver 112 may employ any sort of wireless data communication protocols, for example such as Bluetooth, Bluetooth Low Energy (BLE), near-field communications (NFC), Digital Enhanced Cordless Telecommunications (DECT), Wi-Fi, and the like. The band 102 may operate as a radio frequency identification (RFID) tag. The power supply 114 may include a battery, a solar cell, or the like.

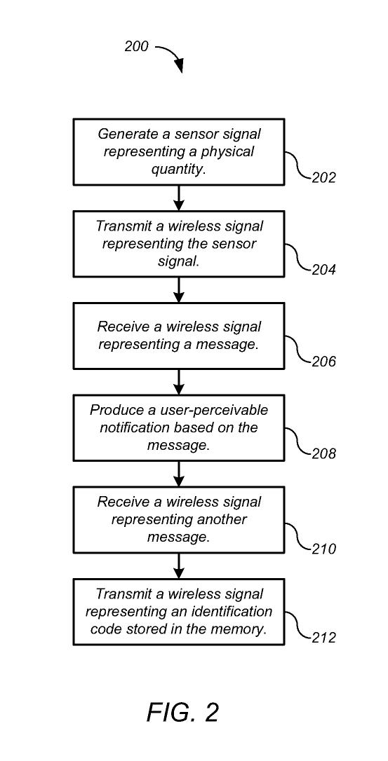

FIG. 2 shows a process 200 for the replaceable watchband 100 of FIG. 1 according to one embodiment. Although in the described embodiments the elements of process 200 are presented in one arrangement, other embodiments may feature other arrangements. For example, in various embodiments, some or all of the elements of process 200 may be executed in a different order, concurrently, and the like. Also some elements of process 200 may not be performed, and may not be executed immediately after each other. In addition, some or all of the elements of process 200 may be performed automatically, that is, without human intervention.

Referring to FIG. 2, at 202, the sensor 130 may generate a sensor signal representing a physical quantity. At 204, the processor 116 may cause the wireless transmitter 110 to transmit a wireless signal representing the sensor signal 130. The wireless signal may be received by a smartphone or the like, which may take action based on the sensor signal. For example, the smartphone may display data collected by the sensor 130.

At 206, the wireless receiver 112 may receive a wireless signal representing a message. Responsive to the message, at 208, the processor 116 may cause the notifier 128 to produce a user-perceivable notification based on the message.

At 210, the wireless receiver 112 may receive a wireless signal representing another message. Responsive to the message, at 212, the processor 116 may cause the wireless transmitter 110 may transmit a wireless signal representing an identification code stored in the memory 118. For example, the received wireless signal may be a prompt for the identification code transmitted by an electronic lock at an entrance to a secure building.

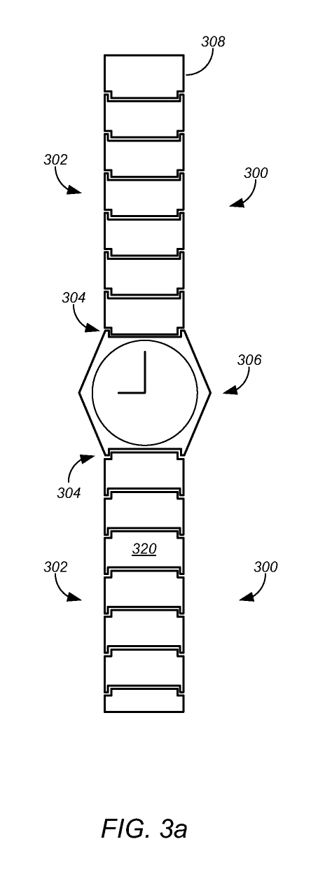

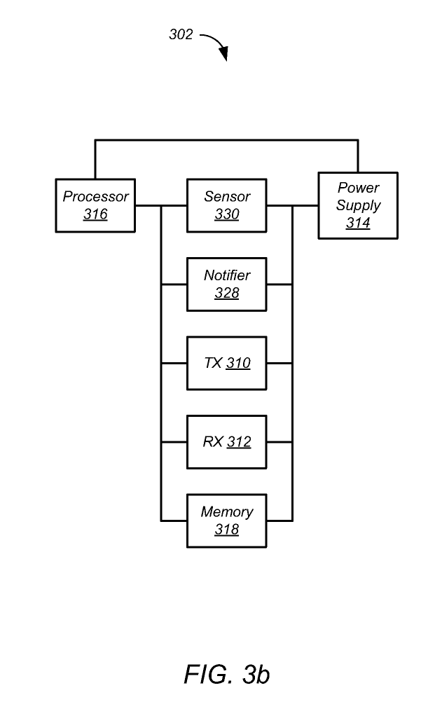

Some wristwatches have integrated watchbands that cannot be replaced, but that include links that can be replaced. FIGS. 3a and 3b show elements of a watchband 300 having a replaceable link 320 implemented according to one embodiment. Although in the described embodiment elements of the link 320 are presented in one arrangement, other embodiments may feature other arrangements. For example, elements of the link 320 may be implemented in hardware, software, or combinations thereof.

Referring to FIG. 3a, the watchband 300 may include a band 302 and a closure structure 308 operable to open and close the watchband 300. The band 302 may be a bracelet comprising a plurality of links, or the like. The watchband 300 may include an attachment structure 304 configured to receive a wristwatch 306. For example, the attachment structure 304 may be a sleeve configured to receive a spring-loaded pin that fits into a pair of lugs on the wristwatch 306. However, the attachment structure 304 may take other forms. In other embodiments, the watchband 300 is integrated with the wristwatch 306. The closure structure 308 may include a clasp, buckle, or the like.

Referring to FIG. 3b, the watchband link 320 may include a sensor 330, a notifier 328, a wireless transmitter (TX) 310, a wireless receiver (RX) 312, a power supply 314, a processor 316, and a memory 318. The elements of the watchband link 320 may be implemented in a manner similar to the corresponding elements of the watchband 100 of FIG. 1, and may operate in a manner similar to that of the process 200 of FIG. 2. In some embodiments, these elements are implemented in more than one link 320. For example, the power supply 314 may be implemented in one link, and the other elements in another link, with power transmitted through the physical connections between the links.

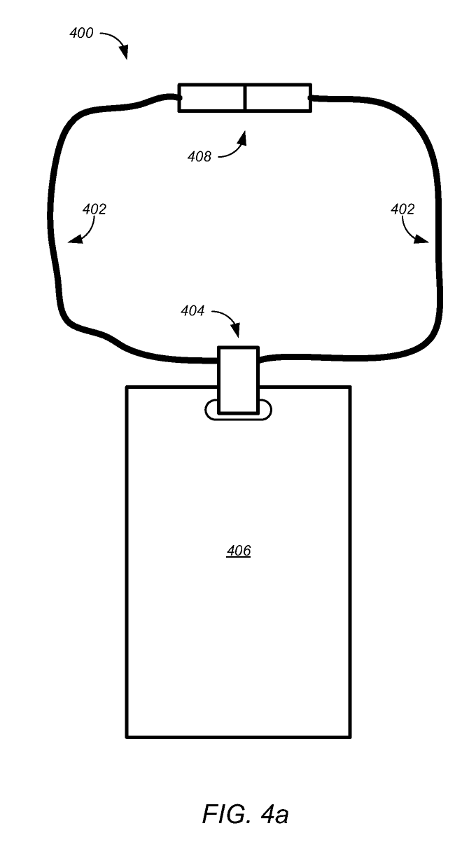

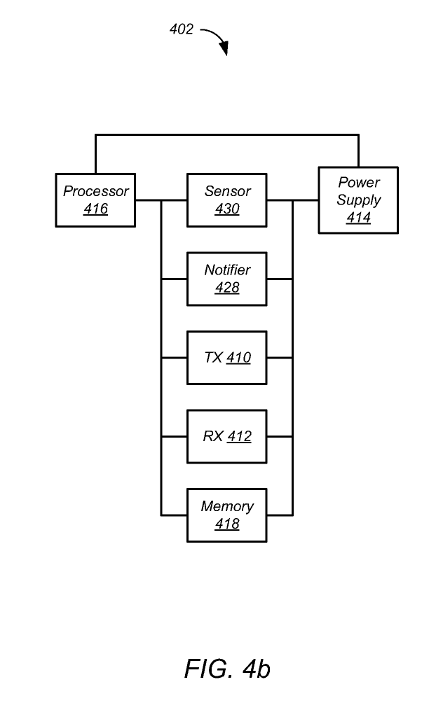

FIGS. 4a and 4b show elements of a lanyard 400 according to one embodiment. Although in the described embodiment elements of the lanyard 400 are presented in one arrangement, other embodiments may feature other arrangements. For example, elements of the lanyard 400 may be implemented in hardware, software, or combinations thereof.

Referring to FIG. 4, the lanyard 400 may include a cord 402 and an attachment structure 404 configured to receive an object such as a badge 406 or the like. The attachment structure 404 may be a spring-loaded clip or the like. The lanyard 400 may include a closure structure 408 operable to open and close the lanyard 400. For example, the closure structure 408 may be a safety breakaway or the like.

The lanyard 400 may include a sensor 430, a notifier 428, a wireless transmitter (TX) 410, a wireless receiver (RX) 412, a power supply 414, a processor 416, and a memory 418. In the embodiment of FIG. 4, these elements are implemented in the attachment structure 404 of the lanyard 400. In other embodiments, these elements may be implemented in other parts of the lanyard 400 such as the closure structure 408. The elements of the lanyard 400 may be implemented in a manner similar to the corresponding elements of the watchband 100 of FIG. 1, and may operate in a manner similar to that of the process 200 of FIG. 2.

Other embodiments may be implemented as smart wireless devices that may be attached to wearables. The examples given below are meant to be illustrative, not limiting. Some embodiments may be implemented as attachments to lanyards. The smart wireless device may be implemented as a rigid ring through which a loop of the lanyard cord 402 may be passed prior to placing the loop over the wearer's head. The smart wireless device may be implemented as a flexible tube that may be closed about the lanyard cord 402. The smart wireless device may be implemented as a flexible package that may be crimped about the lanyard cord 402. The smart wireless device may be implemented as a package that may be attached to wearables such as watchbands, jewelry, and the like. For example, the package may include prongs that may be bent to grasp the wearable. The smart wireless device may be implemented as a back plate for a watch.

Various embodiments of the present disclosure may be implemented in digital electronic circuitry, or in computer hardware, firmware, software, or in combinations thereof. Embodiments of the present disclosure may be implemented in a computer program product tangibly embodied in a computer-readable storage device for execution by a programmable processor. The described processes may be performed by a programmable processor executing a program of instructions to perform functions by operating on input data and generating output. Embodiments of the present disclosure may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, processors receive instructions and data from a read-only memory and/or a random access memory. Generally, a computer includes one or more mass storage devices for storing data files. Such devices include magnetic disks, such as internal hard disks and removable disks, magneto-optical disks; optical disks, and solid-state disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, ASICs (application-specific integrated circuits). As used herein, the term “module” may refer to any of the above implementations.

A number of implementations have been described. Nevertheless, various modifications may be made without departing from the scope of the disclosure. Accordingly, other implementations are within the scope of the following claims.

What is claimed is:

1. A watchband comprising:
a band, wherein the band comprises
(i) a sensor configured to generate a sensor signal representing a physical quantity, and
(ii) a wireless transmitter configured to transmit a wireless signal representing the sensor signal; and
a closure structure operable to close the watchband.

2. The watchband of claim 1, wherein the wireless signal is a first wireless signal, and wherein the band further comprises:
a memory configured to store an identification code;
wherein the wireless transmitter is further configured to transmit a second wireless signal representing the identification code.

3. The watchband of claim 1, wherein the wireless signal is a first wireless signal, and wherein the band further comprises:
a wireless receiver configured to receive a second wireless signal representing a message; and
a notifier configured to produce a user-perceivable notification based on the message.

4. The watchband of claim 1, further comprising:
a power supply.

5. A first watchband link comprising:
an attachment structure configured to receive a second watchband link;
a sensor configured to generate a sensor signal representing a physical quantity; and
a wireless transmitter configured to transmit a wireless signal representing the sensor signal.

6. The first watchband link of claim 5, wherein the wireless signal is a first wireless signal, and wherein the first watchband link further comprises:
a memory configured to store an identification code;
wherein the wireless transmitter is further configured to transmit a second wireless signal representing the identification code.

7. The first watchband link of claim 5, wherein the wireless signal is a first wireless signal, and wherein the first watchband link further comprises:
a wireless receiver configured to receive a second wireless signal representing a message; and
a notifier configured to produce a user-perceivable notification based on the message.

8. The first watchband link of claim 5, further comprising:
a power supply.

9. A lanyard comprising:
a sensor configured to generate a sensor signal representing a physical quantity; and
a wireless transmitter configured to transmit a wireless signal representing the sensor signal.

10. The lanyard of claim 9, further comprising:
an attachment structure configured to attach to an object, wherein the attachment structure comprises the sensor and the wireless transmitter.

11. The lanyard of claim 9, further comprising:
a closure structure configured to close the lanyard, wherein the closure structure comprises the sensor and the wireless transmitter.

12. The lanyard of claim 9, wherein the wireless signal is a first wireless signal, and wherein the lanyard further comprises:
a memory configured to store an identification code;
wherein the wireless transmitter is further configured to transmit a second wireless signal representing the identification code.

13. The lanyard of claim 9, wherein the wireless signal is a first wireless signal, and wherein the lanyard further comprises:
a wireless receiver configured to receive a second wireless signal representing a message; and
a notifier configured to produce a user-perceivable notification based on the message.

14. The lanyard of claim 9, further comprising:
a power supply.
